(19) United States
(12) Patent Application Publication
(10) Pub. No.: US 2015/0075410 A1
(43) Pub. Date: Mar. 19, 2015

(54) Sandwich design welding table

(71) Applicant: Harry H. Wong, South Pasadena, CA (US)

(72) Inventor: Harry H. Wong, South Pasadena, CA (US)

(21) Appl. No.: 13/987,900

(22) Filed: Sep. 14, 2013

(51) Int. Cl. B23K 37/04; B25H 1/02

(52) U.S. Cl. CPC B23K 37/0461; B25H 1/02
USPC 108/28

(57) ABSTRACT

A sandwich design welding table comprises a sandwich design metal table top with a matrix of round access holes, table legs with mounting holes, magnetic tool holders, stop plates, hanging tool trays and table links. Said sandwich design metal table top comprises two identical and relatively thin metal plates separated by cylindrical bushings at some locations of said round access holes and welded together by square metal strips along the edges.

### FIELD OF THE INVENTION

The present invention relates to a class of welding table in general, and particularly to a sandwich design welding table used in welding industry. The present invention comprises a sandwich design metal table top with a matrix of round access holes, angled metal table legs with mounting holes, magnetic tool holders, tool trays and table links. Said matrix of round access holes are made for mounting conventional clamps, work holding and alignment tools. Said sandwich design metal table top comprises two relatively thin but rigid metal plates separated by cylindrical bushings at some locations of the round access holes and welded together by square metal strips along the edges.

### BACKGROUND OF THE INVENTION

Welding tables used in welding industry typically comprises flat table top with a number of round holes for inserting clamping tools. The flat table top is made of relatively thick metal plate so that the clamping tools or other accessories can be inserted to the round holes with enough stability and friction force to clamp the workpiece firmly. Due to the thickness of the metal table top, it will make the welding table comparatively heavy. On the other hand, the round holes on the table top have to be made by precise drilling which is an expensive process in manufacturing. The welding tables are normally rectangular in shape. However, the smallest working area will be one welding table and the form factor will normally be limited to a rectangle. It is the intention of the present invention to overcome these disadvantages.

### SUMMARY OF THE INVENTION

The present invention comprises a sandwich design metal table top with a matrix of round access holes throughout the surface area. The round access holes are made to the standard diameter so that common clamping tools and workholding accessories can be inserted through them. The sandwich design table top is made of two relatively thin but rigid metal plates of the same size and shape with a multiple number of cylindrical bushings placed in between at some locations of the round access holes to form the effective thickness of a normal welding table top. The two metal plates are aligned and welded together with square metal strips filling the gaps along the edges of the two metal plates. This construction results in a lighter welding table top without the expense of rigidity. The effective thickness of the sandwich design welding table top will offer the same function for the round access holes to hold clamping tools as that of a solid metal plate.

Since the sandwich design welding table top is made of two relatively thin metal plates, the round access holes can be manufactured by stamping instead of drilling. Stamping is a cheaper manufacturing process compared to drilling.

The cylindrical bushings are placed between the two thin metal plates at some locations of the round access holes only. The round access holes located immediately next to the table top edges are left without the cylindrical bushings so that the empty holes along the edges can be used to hang welding table accessories such as a tool tray.

The square metal strips along the edges of the sandwich design table top are equipped with screw holes to mount the stop plates for workpiece holding and alignment. The holes on the stop plates are elongated so that the protruding height of the stop plates are adjustable.

The table legs of the present invention are made of angled metal plates instead of sold metal. This reduces the total weight of the present invention and the manufacturing cost also. However, the stability of the present invention remains the same. Table legs are equipped with mounting holes for attaching accessories such as magnetic tool holders.

Table links can be used to connect multiple number of the present invention to form a welding platform of larger working area and various shape according to user requirement. Since the sandwich design table top composes of two relatively thin metal plates instead of one thick metal plate, it can be cut to any desired size and shape by laser cutting machine easily. This adds flexibility to the present invention.

### BRIEF DESCRIPTION OF THE DRAWINGS

FIG. 1 is a perspective view of the present invention;

FIG. 2 is an exploded view of a corner portion of the sandwich design table top of the present invention;

FIG. 3 is a cross-sectional view of the present invention along section A-A with the addition of a tool tray hanged in the free round access hole;

FIG. 4 is a perspective view of a corner of the present invention with the stopping plate;

FIG. 5 is a side view of the present invention with the magnetic tool holder added; and

FIG. 6 is a partial top view showing two of the present invention connected together with the table link.

### DETAILED DESCRIPTION OF THE INVENTION

With the help of the drawings and the detail description below, the features of the present invention will be apparent and fully understandable.

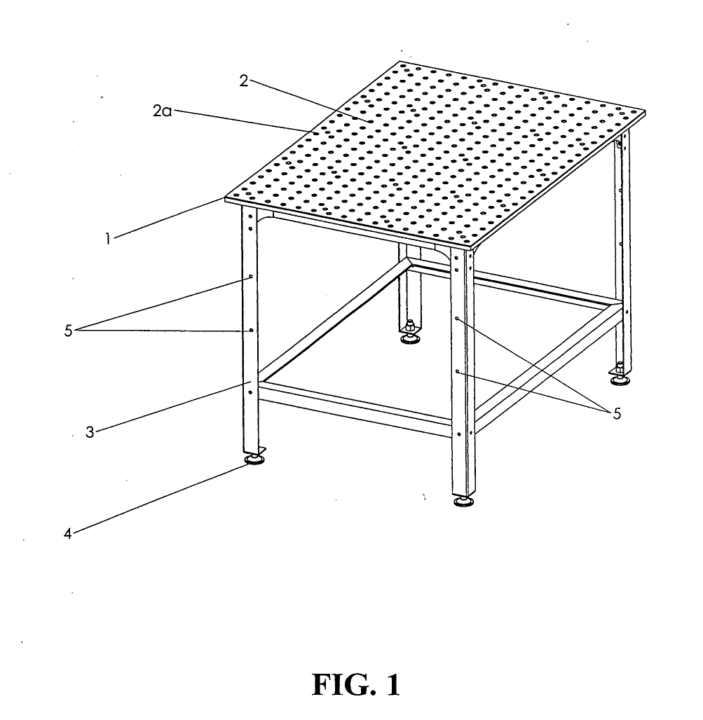

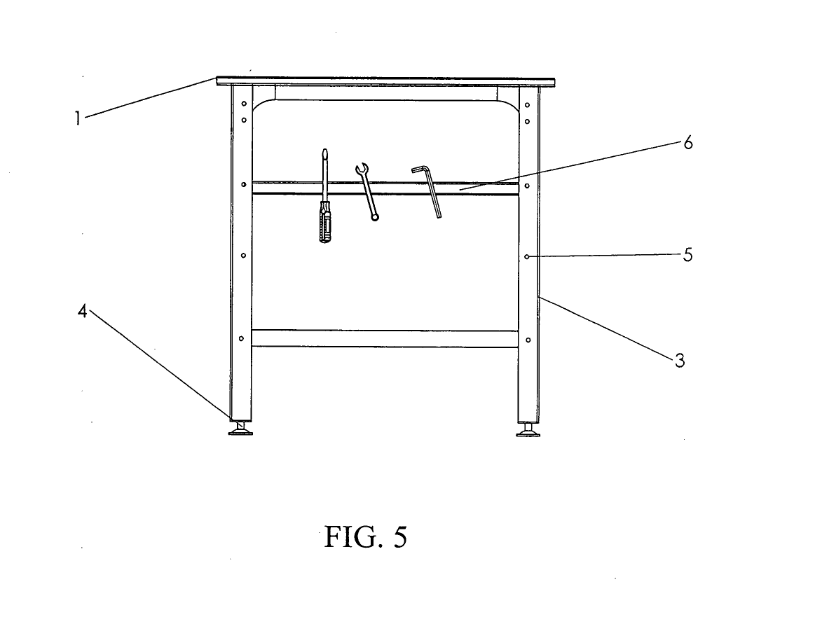

Referring to FIG. 1, the present invention comprises a sandwich design metal table top 1 having a matrix of round access holes 2 throughout the surface area. These round access holes 2 and 2a are made to the standard diameter so that common clamping tools and workholding accessories can be inserted through them. The sandwich design metal table top 1 is supported by a number of table legs 3 equipped with leveling pads 4. As shown in FIG. 1, the table legs 3 is made of angled metal plates instead of solid metal in order to reduce the weight of the welding table. Table legs 3 are equipped with holes 5 for attaching accessories such as magnetic tool holders 6 as shown in FIG. 5.

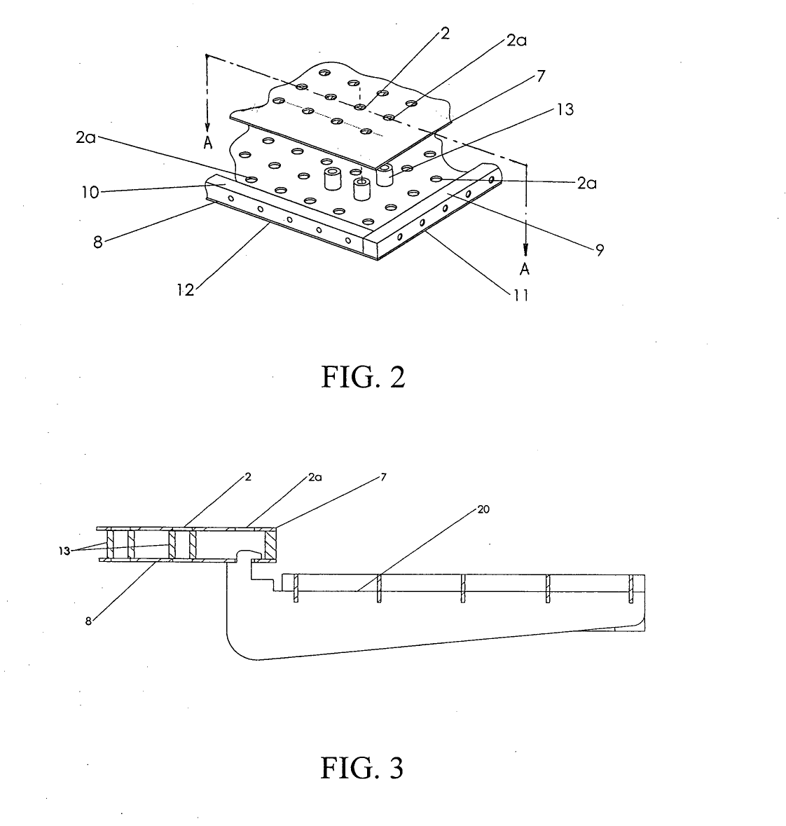

Referring to FIG. 2, the sandwich design metal table top comprises two identical relatively thin metal plates 7 and 8, one on the top and one on the bottom. Both thin metal plates 7 and 8 are equipped with a matrix of round access holes 2 and 2a with the same diameters. Thin metal plate 7 is placed on top of thin metal plate 8 with square metal strips 9 and 10 in between and aligned with edges 11 and 12 respectively. Cylindrical bushings 13 are places between thin metal plate 7 and thin metal plate 8 aligned with some of the round access holes 2. The inside diameter of the cylindrical bushing 13 is the same as the diameter of the round access holes 2. Those round access holes 2a located immediately next to the edges 11 and 12 of the thin metal plate 8 are free of the cylindrical bushings 13 so that these empty round access holes 2a can be used for hanging welding table accessories such as a tool tray 20 as shown in FIG. 3. Thin metal plate 7 and thin metal plate 8 are welded to square metal strips 9 and 10 holding all the bushings 13 in between some locations of the round access holes 2, forming the sandwich design metal table top 1 of the welding table. Those round access holes 2 with cylindrical bushings 13 in between will form the same tooling hole of a conventional welding table and can be used to hold clamping tools and workholding accessories.

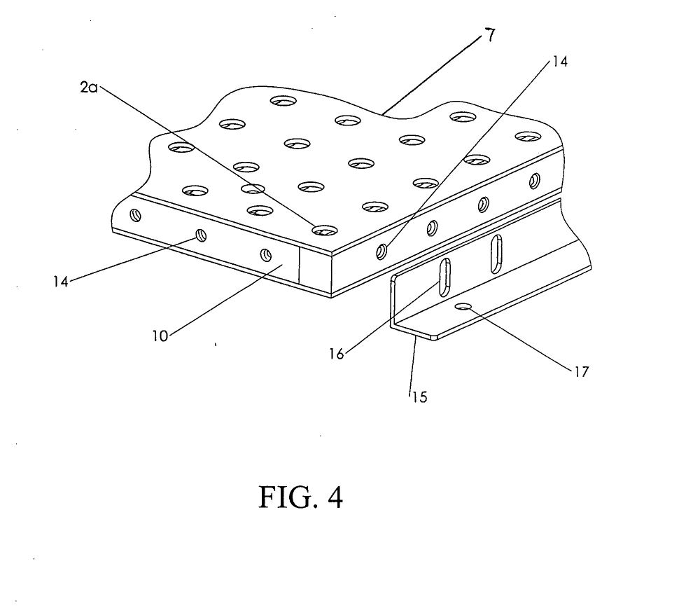

As shown in FIG. 4, along the outside edge of the square metal strips 9 and 10, screw holes 14 are equipped. These screw holes 14 can be used to mount the stop plate 15. Stop plate 15 is an angle metal plate and it is made to have elongated holes 16 along one surface and round holes 17 on the other surface. When the stop plate 15 is mounted to the surface of the square metal strip 9 with screws through elongated holes 16 to screws holes 14, the protrusion of the upper edge of stop plate 15 above the surface of thin metal plate 7 can be adjusted as necessary by the operator.

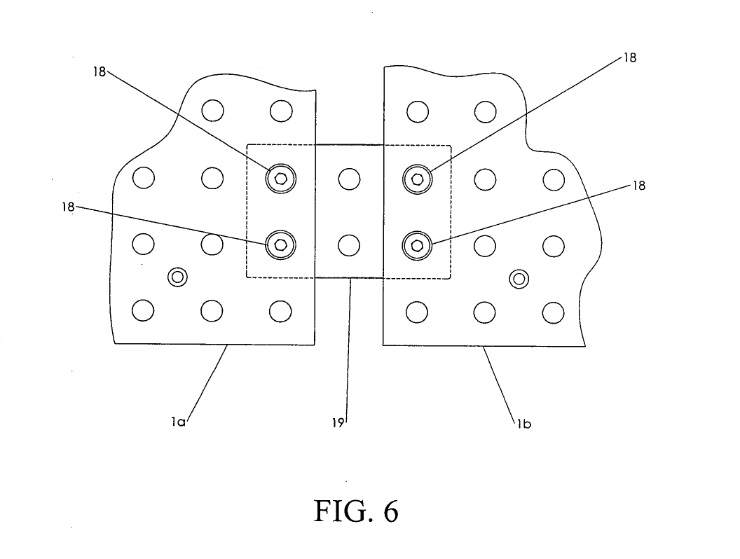

If the working area of one sandwich design welding table is not large enough, more than one present invention can be linked together by table link 19. FIG. 6 shows one sandwich design metal table top 1a is linked to another sandwich design metal table top 1b by table link 19. Table link 19 is a rectangular metal plate equipped with six round holes. Table link 19 is fixed to both sandwich design metal table top by four screws 18. Multiple table link 19 can be used to link multiple sandwich design welding tables together to form a welding table with larger working area. If necessary, the sandwich design metal table top 1 can be cut by laser cutting machine to a smaller size or different shape other than rectangle since the sandwich design metal table top 1 is made of thin metal plates 7 and 8.

What I claim as my invention is:

1. A sandwich design welding table comprising:
a sandwich design metal table top having a matrix of round access holes throughout the surface area;
a plurality of stop plates with elongated holes;
a plurality of table legs made of angled metal plates supporting said sandwich design metal table top; and
a table link to connect multiple numbers of said sandwich design welding table.

2. The sandwich design welding table according to claim 1, wherein said sandwich design metal table top comprising two identical relatively thin metal plates having a matrix of round access holes throughout the surface area, a multiple number of cylindrical bushings putting between said two relatively thin metal plates at some locations of said round access holes, and a plurality of straight metal strips of square cross section placing between said two metal plates along each edge of said thin metal plates.

3. The sandwich design welding table according to claim 2, wherein said relatively thin metal plates are welded together along each edges with said straight metal strips in between said thin metal plates.

4. The sandwich design welding table according to claim 2, wherein said round access holes immediately next to each edge of said relatively thin metal plates are left without said cylindrical bushings in between so that said round access holes immediately next to each edge of said thin metal plate on the bottom can be used to hang welding table accessories.

5. The sandwich design welding table according to claim 2, wherein said cylindrical bushings having inside diameter the same as the diameter of said round access holes.

6. The sandwich design welding table according to claim 2, wherein said straight metal strips are equipped with screw holes on the outer side for mounting said stop plates.

7. The sandwich design welding table according to claim 1, wherein said table legs are equipped with round holes for mounting magnetic tool trays.

8. The sandwich design welding table according to claim 1, wherein said stop plate is made of angled metal plate having one wide surface and one narrow surface, said wide surface is equipped with a plurality of elongated holes and said narrow surface is equipped with a plurality of round holes.

9. The sandwich design welding table according to claim 1, wherein said table link is a rectangular metal plate having a plurality of round holes.
